(19) United States
(12) Patent Application Publication
(10) Pub. No.: US 2009/0040198 A1
(43) Pub. Date: Feb. 12, 2009

(54) METHOD FOR DETECTING PIXEL STATUS OF FLAT PANEL DISPLAY AND DISPLAY DRIVER THEREOF

(75) Inventors: Guan-Ting Lu, Hsinchu city (TW); Cheng-Han Hsieh, Hsinchu (TW)

Correspondence Address: J C PATENTS, INC., 4 VENTURE, SUITE 250, IRVINE, CA, 92618, US

(73) Assignee: SILICON TOUCH TECHNOLOGY INC., Hsinchu (TW)

(21) Appl. No.: 11/836,370

(22) Filed: Aug. 9, 2007

(51) Int. Cl. G06F 3/038

(52) U.S. Cl. 345/204

(57) ABSTRACT

The present invention discloses methods and display drivers for pixel status detection of flat panel displays. The method includes the following steps of: providing scan data to the register; using the scan data to drive the pixel; detecting the pixel status to obtain status data; refreshing the register with the status data; and, comparing the scan data with the status data to determine whether the pixel is in abnormal status or not. Based on the aforementioned method, the pixel status could be real-time monitored.

### BACKGROUND OF THE INVENTION

1. Field of Invention

The present invention relates to flat panel display technology. More particularly, the present invention relates to methods for detecting pixel status of flat panel displays and display drivers thereof.

2. Description of Related Art

Along with the development of technology, video products, especially the digital video/image processing products have become indispensable in our daily life. A display device among the digital video/image processing apparatus is one of the significant devices for displaying related information. Users can read information from the display to further operate the apparatus thereby. A flat panel display manufactured with optoelectronic and semiconductor technologies, e.g. a light emitting diode (LED) display, is highlighted in the display field. Since the LED display has advantages of large size, high display quality, high luminance, and wide view angle so that the LED display becomes a prevailing display of the large size display.

The LED display has the following characteristic: when a pixel of the LED display is damaged, the pixel could be fixed by directly replacing the damaged LED with a new LED. So the technology for detecting the status of LED begins to appear in the LED display. The abnormal status of LEDs in LED display devices includes open-circuit, short-circuit and over temperature. In general, the method for detecting the status of LED may be classified to the following three technique in the prior art.

FIG. 1 is illustrated a LED driver in the prior art for explaining the first technique for detecting the status of LED in the prior art. In the first technique, as shown in FIG. 1, each driving circuit 103-1 to 103-m, connected to a plurality of pixels, has an alarm terminal coupled to the control unit 101. When a pixel in the pixels is in abnormal status and the abnormal status is detected by the driving circuits 103-1˜103-m, an alarm signal is sent to the control unit 101 from the alarm terminal of the driving circuit which is connected to the abnormal pixel in the pixels. Usually the alarm terminals of the driving circuits 103-1 to 103-m are wired together to be coupled to the control unit 101 to reduce pin count of the control unit 101. But by doing so, the control unit 101 has difficulty in judging which pixel is abnormal.

In the second technique in the prior art, a detecting circuit is added to each driving circuit to detect pixel status and report the status to the control unit. The detecting circuit of each driving circuit has its own dedicated wires coupled to the control unit. Therefore the second technique will increase device cost and complexity of design.

In the third technique in the prior art, the driving circuit uses a mode-switch circuit and two control signals to switch the driving circuit between the display mode and the non-display mode. This technique has been disclosed by U.S. Pat. No. 6,930,679 B2. When the driving circuit is in the non-display mode, the serial data line can carry the pixel status information. But using two control signals will increase complexity of firmware design and switching to the non-display mode may interrupt the images being displayed. This technique also can't meet the real-time monitoring requirement.

### SUMMARY OF THE INVENTION

Accordingly, methods and display drivers for pixel status detection of flat panel display devices are disclosed in the present invention. By the present invention, no mode-switch circuit is required for pixel status detection. And because pixel status data are collected while the pixels are displaying images without interruption, the so-called real-time monitoring is achieved. Moreover, by comparing the scan data with the status data, the position of the abnormal pixel can be pinpointed.

It is an object of the invention to provide methods for pixel status detection of flat panel displays.

A method for pixel status detection of a flat panel display, which includes a display driver with a register to drive a pixel, comprises steps of: providing scan data to the register; using the scan data to drive the pixel; detecting the pixel status to obtain status data; refreshing the register with the status data; and comparing the scan data and the status data to determine whether the pixel is in abnormal status or not.

Another method for pixel status detection of a flat panel display, which includes a display driver with n shift registers to drive n pixels, comprises steps of: enabling the n pixels by the driver; detecting the n pixels' status to obtain the n status data; refreshing the n shift registers with the n status data; and determining which pixel in the n pixels is in abnormal status, according to the n status data, wherein n is a nature number.

It is another object of the invention to provide a display driver for pixel status detection of flat panel displays. The display driver, coupled to a plurality of pixels of a display, comprises m driving circuits and a control unit.

Each driving circuit of the display driver comprises: a data input terminal; a data output terminal, wherein the data output terminal of the i^{th} driving circuit is coupled to the data input terminal of the (i+1)^{th} driving circuit; n driving terminals, coupled to n pixels in the pixels respectively; n shift registers, wherein each shift register comprises a input terminal and an output terminal, wherein the output terminal of the i^{th} shift register is coupled to the input terminal of the (i+1)^{th} shift register and the i^{th} driving terminal, wherein m, n, and i are nature numbers and 0<i<=n; and a detecting device, comprising n detecting terminals and n output terminals, wherein the detecting terminals of the detecting device respectively are coupled to the driving terminals, and the output terminals of the detecting device respectively are coupled to the shift registers, for detecting the n pixels' status to output status data to the shift registers.

The control unit of the display driver comprises a receiving terminal and a scan data terminal, wherein the scan data terminal is coupled to the data input terminal of the 1st driving circuit, and the receiving terminal is coupled to the data output terminal of the m^{th} driving circuit to receive the status data sequentially, wherein the data input terminal of the 1 st driving circuit sequentially receives the scan data from the scan data terminal of the control unit according to a clock signal.

By the present invention, the following benefits can be achieved: positions of pixels which are in abnormal status can be pinpointed; no mode-switch circuit is required for pixel status detection and the number of terminals used for pixel status detection can be reduced; and real-time monitoring and invisible detection can be achieved without any interruption of the images being displayed.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of a conventional display driver for pixel status detection.

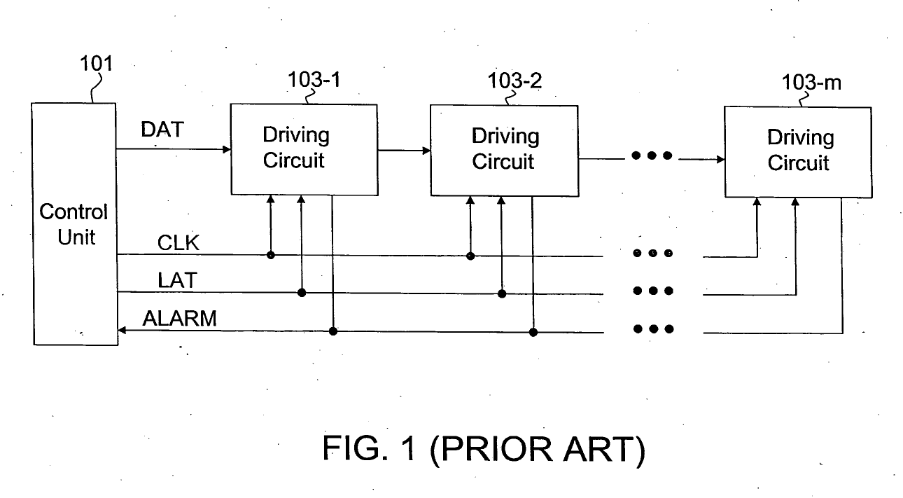

FIG. 2 is a schematic block diagram of a display driver for LED status detection according to a first embodiment of the present invention.

FIG. 3 is a schematic block diagram of the internal connection of a LED driving circuit according to the first embodiment of the present invention.

FIG. 4 is a flow chart illustrating a method for LED status detection according to the first embodiment of the present invention.

FIG. 5 is a schematic block diagram of a display driver for LED status detection with smart detection function according to a second embodiment of the present invention.

FIG. 6 is a schematic block diagram of the internal connection of a LED driving circuit with smart detection function according to the second embodiment of the present invention.

FIG. 7 is a flow chart illustrating a method for LED status detection with smart detection function according to the second embodiment of the present invention.

FIG. 8 is a timing diagram of a smart detection process according to the second embodiment of the present invention.

### DESCRIPTION OF EMBODIMENTS

Since the LED display has advantages of large size, high display quality, high luminance, and wide view angle so that the LED display becomes a prevailing display of the large size display. In the following, the LED display is used as an example to describe the embodiment of the present invention. But it should be noted that although in the following embodiments the pixel in the display is implemented by a LED, in other embodiments the pixel can be implemented by a thin film transistor and liquid crystal, an organic light emitting diode (OLED) or other light emitting device.

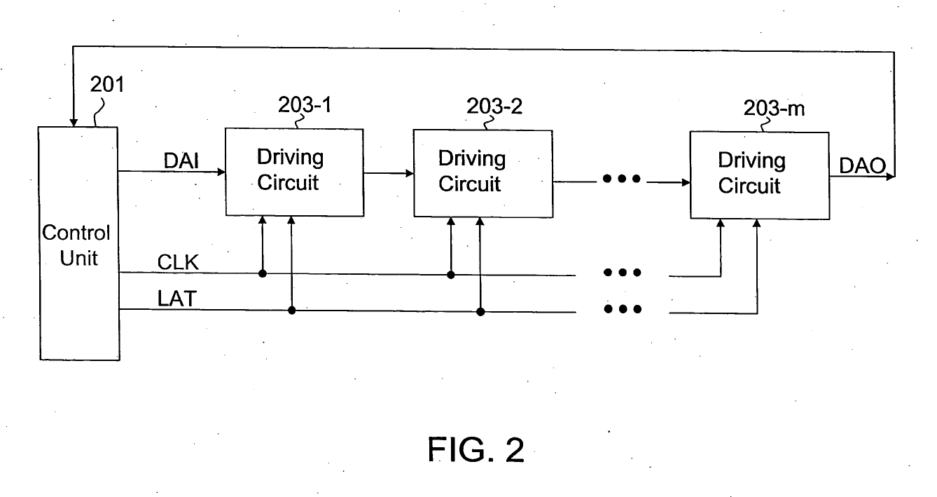

FIG. 2 is a schematic block diagram of a display driver for LED status detection according to a first embodiment of the present invention. Referring to FIG. 2, the display driver comprises a control unit 201 and m driving circuits 203-1 to 203-m. The m driving circuits 203-1 to 203-m are connected in cascade. If each of the driving circuits 203-1 to 203-m can drive n LEDs, the display driver in FIG. 2 can drive m×n LEDs. Each driving circuit has a data input (DAI) terminal and a data output (DAO) terminal. Shift registers in each driving circuit 203-1 to 203-m can shift input data, bit by bit, from the data input (DAI) terminal toward the data output (DAO) terminal. The data input terminal of the driving circuit 203-1 is coupled to the scan data terminal of the control unit 201. And the scan data, carrying data of images to be displayed, are sent from the control unit 201 to the driving circuits 203-1 to 203-m via the scan data terminal. The data output terminal of the first driving circuit 203-1 is coupled to the data input terminal of the second driving circuit 203-2; the data output terminal of the second driving circuit 203-2 is coupled to the data input terminal of the third driving circuit (not shown in FIG. 2); and so on. The data output terminal of the last driving circuit 203-m is coupled to the receiving terminal of the control unit 201. Scan data are sent by the control unit 201 to driving circuits 203-1 to 203-m serially, one bit of scan data is sent in every clock (CLK).

A detecting device in every driving circuit 203-1 to 203-m in FIG. 2 can detect the status of LEDs, while these LEDs are displaying an image, for example, image #K. When scan data of a new image, image #K+1, have been sent from the control unit 201 to shift registers in the driving circuits 203-1 to 203-m, the control unit will send a latch (LAT) signal to latch registers in the driving circuits 203-1 to 203-m to latch the scan data and a driving buffer device in each driving circuit 203-1 to 203-m will drive LEDs according to the data latched in the latch registers. At the same time when the latch signal is received by the driving circuits 203-1 to 203-m, the detecting devices in every driving circuit 203-1 to 203-m will load the status data, carrying data of status of LEDs, to the shift registers in the driving circuits 203-1 to 203-m. These LED status data will be shifted out via data output (DAO) terminals of the driving circuits 203-1 to 203-m serially in synchronization with the clock (CLK) signal to the control unit 201 when the next new scan data, carrying data of image #K+2, are sent to the driving circuits 203-1 to 203-m.

Only when a LED is turned on by a driver, the result of the status detection of that LED can be meaningful. So the control unit 201 can only determine whether those LEDs which have been turned on are in abnormal status. The control unit 201 can save the LED status data and the corresponding scan data in a memory device and compare the status data with the scan data to pinpoint the exact positions of those abnormal LEDs.

If all LEDs' status has to be detected, the control unit 201 can send scan data which carry data of a white image to the driving circuits 203-1 to 203-m to turn on all LEDs. Because the LED status data will be shifted to the control unit 201 serially in synchronization with the clock (CLK) signal, the control unit 201 can count the clock (CLK) signal to pinpoint the exact positions of those abnormal LEDs.

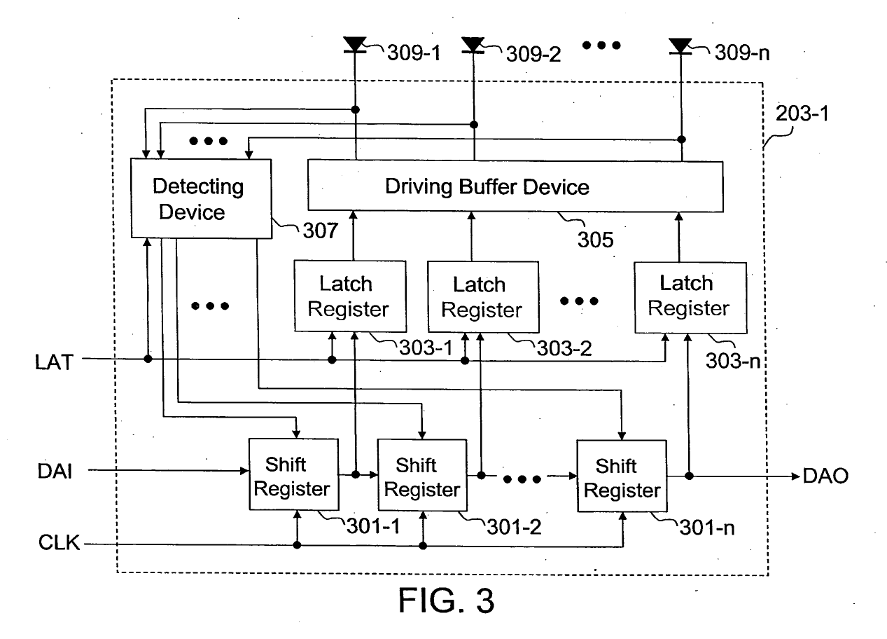

FIG. 3 is a schematic block diagram of the internal connection of a driving circuit, for example, 203-1 in FIG. 2 according to the first embodiment of the present invention. Referring to FIG. 3, the driving circuit 203-1 for driving, for example, n LEDs comprises n shift registers 301-1 to 301-n, n latch registers 303-1 to 303-n, a driving buffer device 305, a detecting device 307, a data input (DAI) terminal, a data output (DAO) terminal, a clock (CLK) input terminal and a latch (LAT) input terminal.

For the n shift registers 301-1 to 301-n, the data output terminal of the i^{th} shift register is coupled the data input terminal of the (i+1)^{th} shift register, wherein i is an integer and 0<i<=n.

For the n latch registers 303-1 to 303-n, the output terminal of the j^{th} latch register is coupled to the driving buffer device 305 to drive the j^{th} LED, and the input terminal of the j^{th} latch register is coupled to the output terminal of the j^{th} shift register, wherein j is an integer and 0<j<=n.

For the driving buffer device 305, its input terminals are coupled to the output terminals of n latch registers 303-1 to 303-n, and its output terminals are coupled to n LEDs.

For the detecting device 307, its input terminals are coupled to LEDs, and its output terminals are coupled to n shift registers 301-1 to 301-n.

The data input (DAI) terminal of the driving circuit 203-1 is coupled to the input terminal of the first shift register 301-1. The data output (DAO) terminal of the driving circuit 203-1 is coupled to the output terminal of the n^{th} shift register 301-n. The clock (CLK) input terminal provides a clock signal to the driving circuit 203-1. The latch (LAT) input terminal is coupled to n latch registers 303-1 to 303-n and the detecting device 307.

The CLK and LAT signals are sent to the driving circuit 203-1 from a control unit.

The detecting device 307 in FIG. 3 can detect the status of n LEDs 309-1 to 309-n, while these LEDs are displaying an image, for example, image #K. When scan data of a new image, image #K+1, have been sent to shift registers 301-1 to 301-n, a latch (LAT) signal will be sent to the latch registers 303-1 to 303-n to latch the scan data and the driving buffer device 305 will drive LEDs 309-1 to 309-n according to data latched in the latch registers 303-1 to 303-n. At the same time when the latch signal is received, the detecting device 307 will load the status data of LEDs 309-1 to 309-n to the shift registers 301-1 to 301-n. These LED status data will be shifted out serially in synchronization with the clock (CLK) signal via the data output (DAO) terminal when scan data of a new image, image #K+2, are shifted in via the data input (DAI) terminal.

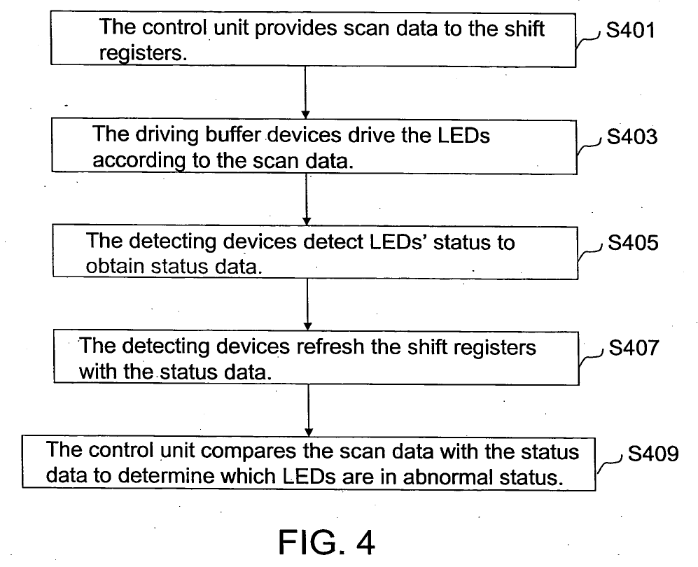

FIG. 4 is a flow chart illustrating a method for LED status detection according to the first embodiment of the present invention. Referring to FIG. 4, firstly, the control unit provides scan data to the shift registers (S401). Then the driving buffer devices will drive the LEDs according to the scan data (S403). The detecting devices can detect LEDs' status to obtain status data (S405). Then the detecting devices refresh the shift registers with the status data (S407). Finally, the status data will be shifted to the control unit and the control unit can compare the scan data with the status data to determine which LEDs are in abnormal status (S409).

The following example is used to describe the implementation of the first embodiment of the present invention. Assume the control unit 201 sends n-bit scan data, for example, 01 . . . 1, as the data of the image #K, to the driving circuit 203-1 in FIG. 3. That is, a bit of logic 0 is shifted to the first shift register 301-1, a bit of logic 1 is shifted to the second shift register 301-2, . . . , and a bit of logic 1 is shifted to the nth shift register 301-n. The latch registers 303-1 to 303-n will latch the scan data of image #K when a latch (LAT) signal is sent to the driving circuit 203-1. Then the driving buffer device will drive LEDs 309-1 to 309-n according to the data latched in the latch registers 303-1 to 303-n. In this example the scan data are n bits, 01 . . . 1, so after the scan data are latched by latch registers 303-1 to 303-n, the first LED 309-1 is turned off, the second LED 309-2 is turned on, . . . , and the n^{th} LED 309-n is turned on.

The detecting device 307 can detect the status of LEDs 309-1 to 309-n, now displaying image #K. It should be noted that only for those LEDs which are lit, the results of the status detection are meaningful. Assume the second LED 309-2 is abnormal. The detecting device 307 will find the second LED 309-2 is abnormal and saves an abnormal status bit, for example a bit of logic 0, in the second bit of the status data. For clarification, the status data corresponding to the status of LEDs when displaying image #K is called status data #K here.

When n-bit scan data of next image, image #K+1, have been sent to shift registers 301-1 to 301-n, a latch (LAT) signal is sent to the driving device 203-1 again. When the latch (LAT) signal is received by the driving device 203-1, the detecting device 307 will load the status data #K to the shift registers 301-1 to 301-n. In this example, the second bit, which is logic 0, of the status data #K is loaded to the second shift register 301-2. The status data #K in the shift registers 301-1 to 301-n will be shifted to the control unit 201 when next n-bit scan data, for image #K+2, are sent to shift registers 301-1 to 301-n.

The control unit 201 can compare the scan data of image #K with the status data #K to determine which LED is abnormal. A bit of logic 1 in the scan data indicates the corresponding LED is turned on and the result of status detection of that LED is meaningful. In this example, the second bit of the scan data of image #K is logic 1 while the second bit of the status data #K is logic 0. So the control unit 201 knows the second LED 309-2 is abnormal.

From the above, no mode-switch circuit and extra control terminals are required for LED status detection. Because LEDs status data are collected while the LEDs are displaying images without interruption, the so-called real-time monitoring is achieved. Moreover, by comparing the scan data with the status data, the position of the abnormal LED can be pinpointed.

What should be noted is, although the above embodiment is a possible structure of the present invention for LED status detection, it will be apparent to those skilled in the art that various modifications and variations can be made to the structure of the present invention without departing from the scope or spirit of the invention. That is, any invention with methods to refresh the register with the status data and compare the scan data with the status data to determine whether the pixel of a flat panel display is in abnormal status or not is within the scope or spirit of the present invention.

In the following, more embodiments will be described, so that those skilled in the art can implement the present invention easily.

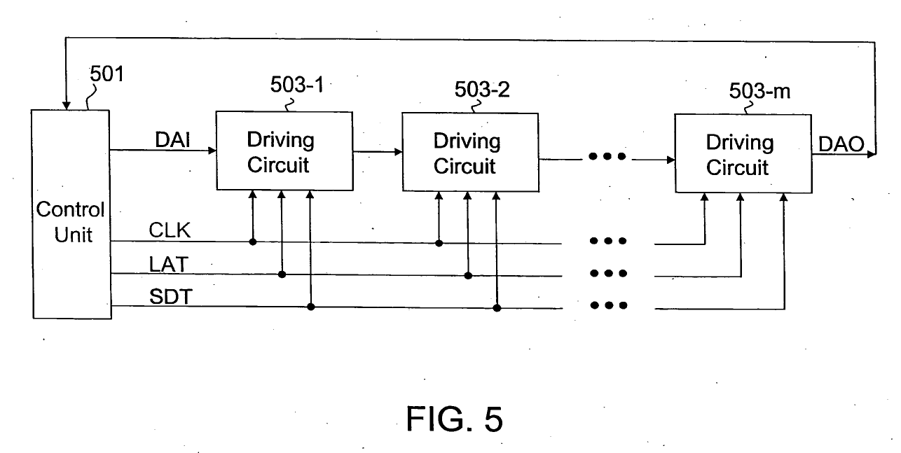

FIG. 5 is a schematic block diagram of a display driver for LED status detection with smart detection function according to a second embodiment of the present invention. Referring to FIG. 5, the display driver comprises a control unit 501 and m driving circuits 503-1 to 503-m. The m driving circuits 503-1 to 503-m are connected in cascade. If each of the driving circuits 503-1 to 503-m can drive n LEDs, the display driver in FIG. 5 can drive m×n LEDs. Each driving circuit 503-1 to 503-m has a data input (DAI) terminal and a data output (DAO) terminal. Shift registers in each driving circuit 503-1 to 503-m can shift input data, bit by bit, from the data input (DAI) terminal toward the data output (DAO) terminal. The data input terminal of the first driving circuit 503-1 is coupled to the scan data terminal of the control unit 501. The data output terminal of the first driving circuit 503-1 is coupled to the data input terminal of the second driving circuit 503-2; the data output terminal of the second driving circuit 503-2 is coupled to the data input terminal of the third driving circuit (not shown in FIG. 3); and so on. The data output terminal of the last driving circuit 503-m is coupled to the receiving terminal of the control unit 501. Scan data, carrying data of images to be displayed, are sent by the control unit 501 via its scan data terminal to driving circuits 503-1 to 503-m serially, one bit of scan data is sent in every clock (CLK).

A smart detection (SDT) signal is used in FIG. 5. A smart detection process starts when the smart detection (SDT) signal, sent by the control unit 501, is received by the driving circuits 503-1 to 503-m and ends when the first latch (LAT) signal following the smart detection signal is received by the driving circuits 503-1 to 503-m. Driving buffer devices in the driving circuits 503-1 to 503-m will drive and turn on all LEDs when a smart detection (SDT) signal is received by the driving circuits 503-1 to 503-m, wherein the driving buffer devices will reduce the brightness of all LEDs when lighting them, so human eyes can't sense any interruption of images being displayed in a display device and the so-called invisible detection can be achieved when the smart detection is in process. Detecting devices in the driving circuits 503-1 to 503-m will detect the status of LEDs when all LEDs are lit and load the status data, carrying data of status of LEDs, to shift registers in the driving circuits 503-1 to 503-m. These LED status data will be shifted out via data output (DAO) terminals of the driving circuits 503-1 to 503-m to the control unit 501 serially in synchronization with the clock (CLK) signal following the smart detection (SDT) signal. Because the status data of LEDs will be shifted to the control unit 501 serially in synchronization with the clock (CLK) signal, the control unit 501 can count the clock (CLK) signal to pinpoint the exact positions of those abnormal LEDs.

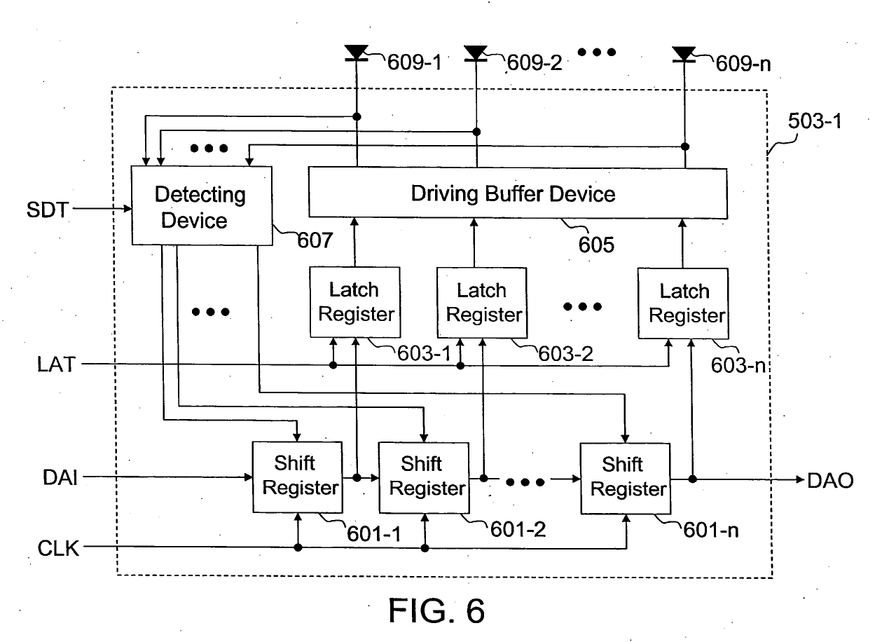

FIG. 6 is a schematic block diagram of the internal connection of a driving circuit, for example, 503-1 in FIG. 5 with the smart detection function according to the second embodiment of the present invention. Referring to FIG. 6, the driving circuit 503-1 for driving, for example, n LEDs comprises n shift registers 601-1 to 601-n, n latch registers 603-1 to 603-n, a driving buffer device 605, a LED status detection circuit 607, a data input (DAI) terminal, a data output (DAO) terminal, a clock (CLK) input terminal, a latch (LAT) input terminal and a smart detection (SDT) input terminal.

For the n shift registers 601-1 to 601-n, the data output terminal of the i^{th} shift register is coupled the data input terminal of the (i+1)^{th} shift register, wherein i is an integer and 0<i<n.

For the n latch registers 603-1 to 603-n, the output terminal of the j^{th} latch register is coupled to the driving buffer device 605 to drive the j^{th} LED, and the input terminal of the j^{th} latch register is coupled to the output terminal of the j^{th} shift register, wherein j is an integer and 0<j<=n.

For the driving buffer device 605, its input terminals are coupled to the output terminals of n latch registers 603-1 to 603-n, and its output terminals are coupled to n LEDs.

For the detecting device 607, its input terminals are coupled to LEDs, and its output terminals are coupled to n shift registers 601-1 to 601-n.

The data input (DAI) terminal of the driving circuit 503-1 is coupled to the input terminal of the first shift register 601-1. The data output (DAO) terminal of the driving circuit 503-1 is coupled to the output terminal of the nth shift register 601-n. The clock (CLK) input terminal provides a clock signal to the driving circuit 503-1. The latch (LAT) input terminal is coupled to n latch registers 603-1 to 603-n. The smart detection (SDT) input terminal is coupled to the detecting device 607.

The CLK, LAT and SDT signals are sent to the driving circuit 503-1 from a control unit.

Also in FIG. 6, the smart detection process starts when a smart detection (SDT) signal is received by the driving circuit 503-1 and ends when the first latch (LAT) signal following the smart detection signal is received by the driving circuit 503-1. The driving buffer device 605 will drive and turn on all n LEDs 609-1 to 609-n when a smart detection (SDT) signal is received by the driving circuit 503-1. The detecting device 607 can directly control the driving buffer device 605 to drive and turn on all n LEDs 609-1 to 609-n, or the detecting device 607 can load, for example, all is to n shift registers 601-1 to 601-n to control the driving buffer device 605 to drive and turn on all n LEDs 609-1 to 609-n. When the driving buffer device 605 is lighting n LEDs 609-1 to 609-n under smart detection, the driving buffer device 605 will reduce the brightness of all n LEDs 609-1 to 609-n, so human eyes can't sense any interruption of the images in a display device when the smart detection is in process. The detecting device 607 will detect the status of n LEDs 609-1 to 609-n when all n LEDs are lit and load the status data of n LEDs to n shift registers 601-1 to 601-n. These LED status data will be shifted out via the data output (DAO) terminal serially in synchronization with the clock (CLK) signal following the smart detection (SDT) signal.

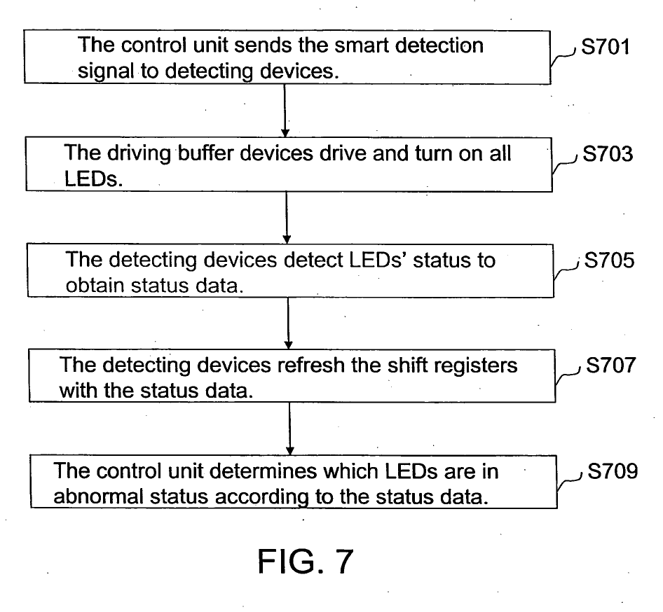

FIG. 7 is a flow chart illustrating a method for LED status detection with smart detection function according to the second embodiment of the present invention. Referring to FIG. 7, firstly, the control unit sends the smart detection signal to detecting devices (S701). Then the detecting devices will control the driving buffer devices to drive and turn on all LEDs (S703). The detecting devices can detect all LEDs' status to obtain status data (S705). Then the detecting devices refresh the shift registers with the status data (S707). Finally, the status data will be shifted to the control unit and the control unit can determine which LEDs are in abnormal status according to the status data (S709).

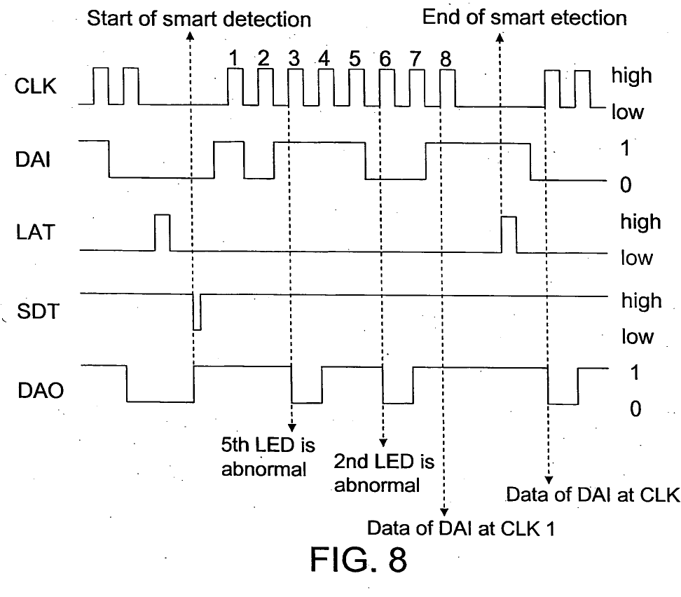

FIG. 8 is a timing diagram of a smart detection process according to the second embodiment of the present invention. The clock (CLK), data input (DAI), latch (LAT), smart detection (SDT) and data output (DAO) signals are shown in the timing diagram. Referring to FIG. 8, a driving circuit which can drive eight LEDs is used as an example. The smart detection process starts when a smart detection (SDT) signal is received by the driving circuit and ends when the first latch (LAT) signal following the smart detection (SDT) signal is received by the driving circuit.

All eight LEDs will be turned on and all eight LEDs' status will be detected when the SDT signal is received by the driving circuit. Then the status data of eight LEDs will be loaded to the eight shift registers to be shifted out via the DAO signal to the next device, which may be a control unit or another driving circuit. The DAO signal will be synchronous with the rising edge of the clock (CLK) signal as shown in FIG. 8. If logic “1” represents a normal LED status and logic “0” represents an abnormal LED status, the DAO signal in FIG. 8 shows the 2^{nd} LED and the 5^{th} LED are abnormal, wherein the order of the eight LEDs is in the order from the data input (DAI) terminal to the data output (DAO) terminal of the driving circuit.

Although the above embodiment of the present invention uses the LED display as examples, it should be noticed that the methods and the display drivers disclosed in the present invention can be applied to any kind of flat panel displays.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for detecting pixel status of a flat panel display, the flat panel display includes a display driver which has a register, and to drive a pixel in the flat panel display, the method comprising:
providing scan data to the register;
using the scan data to drive the pixel;
detecting the pixel status to obtain status data;
refreshing the register with the status data; and
comparing the scan data with the status data to determine whether the pixel is in abnormal status or not.

2. The method as claimed in claim 1, wherein the register includes n shift registers to drive n pixels, each of the shift register includes a data input terminal, a data output terminal, and a clock terminal, the data output terminal of the i^{th} shift register is coupled to the data input terminal of the (i+1)^{th} shift register, the clock terminal of the register receives a clock signal, the data input terminal of the 1^{st} shift register receives the scan data.

3. The method as claimed in claim 2, wherein detecting the pixel status to obtain the status data comprising:
detecting active pixels status in all the pixels; and
when the k^{th} pixel is in abnormal status and detected, saving an abnormal status bit at the k^{th} bit of the status data, wherein k is a nature number and 0<=k<=n.

4. The method as claimed in claim 3, wherein refreshing the register with the status data comprising:
refreshing the k^{th} shift register with the k^{th} bit of the status data.

5. The method as claimed in claim 1, wherein the pixel is a light emitting diode.

6. A method for detecting pixel status of a flat panel display, the flat panel display which includes n pixels includes a display driver which has n shift registers to store scan data for driving n pixels, the method comprising:
enabling the n pixels by the driver;
detecting the n pixels status to obtain the n status data;
refreshing the n shift registers with the n status data; and
determining which pixel in the n pixels is in abnormal status, according to the n status data,
wherein n is a nature number.

7. The method as claimed in claim 6, wherein each shift register includes a data input terminal, a data output terminal, and a clock terminal, the data output terminal of the i^{th} shift register is coupled to the data input terminal of the (i+1)^{th} shift register, the clock terminal of the register is received a clock signal, the data input terminal of the 1^{st} shift register receives n-bit scan data sequentially in a scan period according to the clock signal.

8. The method as claimed in claim 6, wherein detecting the pixels to obtain n-bit status data comprising:
when that the k^{th} pixel is in abnormal status and detected, saving an abnormal status bit at the k^{th} bit of the status data, wherein k is a nature number and 0<=k<=n.

9. The method as claimed in claim 8, wherein refreshing the register with the status data comprising:
refreshing the k^{th} shift register with the k^{th} bit of the status data.

10. The method as claimed in claim 6, wherein the pixels are the light emitted diodes.

11. A display driver which is coupled to a plurality of pixels of a display, the driver comprising:
m driving circuits, each of the driving circuits comprises:
a data input terminal;
a data output terminal, wherein data output terminal of the i^{th} driving circuit is coupled to the data input terminal of the (i+1)^{th} driving circuit;
n driving terminals, coupled to n pixels in the pixels respectively;
n shift register, each the shift register comprises a input terminal and an output terminal, wherein the output terminal of the i^{th} shift register is coupled to the input terminal of the (i+1)^{th} shift register and the i^{th} driving terminal, wherein m, n, and i are nature numbers and 0<i<=n;
a detecting device, comprising n detecting terminals and n output terminals, wherein the detecting terminals of the detecting device respectively are coupled to the driving terminals, and the output terminals of the detecting device respectively are coupled to the shift registers, for detecting the n pixels' status to output status data to the shift registers; and
a control unit, comprising a receiving terminal and a scan data terminal, wherein the scan data terminal is coupled to the data input terminal of the 1^{st} driving circuit, and the receiving terminal is coupled to the data output terminal of the m^{th} driving circuit to receive the status data sequentially, wherein the data input terminal of the 1^{st} driving circuit sequentially receives the scan data from the scan data terminal of the control unit according to a clock signal.

12. The display driver as claimed in claim 11, further comprising:
n latch registers, each of the latch registers comprises:
a latch input terminal;
a latch output terminal; and
a latch enable terminal, receiving a latch enable signal, wherein when the latch enable signal is received, the latch register will latch the data received from the latch input terminal to the latch output terminal;
wherein the latch output terminal of the j^{th} latch register is coupled to the j^{th} driving terminal, the latch input terminal of the j^{th} latch register is coupled to the j^{th} shift register, wherein j is a nature number and 0<j<=n.

13. The display driver as claimed in claim 12, further comprising a driving buffer coupled between the j^{th} latch register and the j^{th} driving terminal.

14. The display driver as claimed in claim 11, wherein the detecting device comprising a smart detection terminal, received a smart detection signal for controlling the detecting device to output n-bit specific data to the n shift registers respectively,
wherein the shift registers enable the pixels by the specific data, the detecting device detects the n pixels and output n specific result data to the shift registers.

15. The display driver as claimed in claim 11, wherein the plurality of pixels is a plurality of light emitting diodes.
